(19) United States
(12) Patent Application Publication
(10) Pub. No.: US 2010/0289198 A1
(43) Pub. Date: Nov. 18, 2010

(54) MULTILAYERED CANTED COIL SPRINGS AND ASSOCIATED METHODS

(76) Inventors: Pete Balsells, Foothill Ranch, CA (US); Majid Ghasiri, Foothill Ranch, CA (US); Daniel Poon, Foothill Ranch, CA (US); Russell Beemer, Foothill Ranch, CA (US); Dick Shepard, Foothill Ranch, CA (US)

Correspondence Address: KLEIN, O'NEILL & SINGH, LLP, 18200 VON KARMAN AVENUE, SUITE 725, IRVINE, CA, 92612, US

(21) Appl. No.: 12/767,421

(22) Filed: Apr. 26, 2010

Related U.S. Application Data
(60) Provisional application No. 61/173,509, filed on Apr. 28, 2009.

(51) Int. Cl. F16F 1/00; F16F 1/06; B21F 35/00

(52) U.S. Cl. 267/151; 29/896.93

(57) ABSTRACT

Multilayered canted coil springs and methods that improve mechanical, electrical and thermal properties of canted coil springs. In some embodiments, properties of dissimilar materials are combined into the spring using various material layers. For example, in one embodiment a protective or high strength outer layer material shields a more sensitive inner core material from harsh environments and conditions. The inner core material may be a highly electrically conductive material, with the outer layer material having an electrical conductivity lower than the core. In various embodiments the following characteristics of the spring are improved: electrical and/or thermal conductivity, corrosion resistance, biocompatibility, temperature resistance, stress relaxation, variable frictional force, and wear resistance in harsh environments and conditions.

### CROSS-REFERENCE TO RELATED APPLICATION

This application claims priority to provisional application Ser. No. 61/173,509, filed on Apr. 28, 2009, the entire contents of which are hereby expressly incorporated herein by reference.

### BACKGROUND

Canted coil springs are generally discussed herein with discussions directed to canted coil springs formed of multilayered spring wire having discrete layers of varying material compositions.

### DESCRIPTION OF RELATED ART

FIGS. 1-3 illustrate examples of canted coil springs 30, 32, 34. Canted coil springs are springs in which the profile of each coil 36, 38, 40 tilts, or cants, to lean at an angle relative to a line that is perpendicular to the spring axis. The spring axis 42, shown in FIG. 2, passes through the center point of each coil 36, 38, 40. Some canted coil springs comprise a length of coiled spring that has its ends connected to form a circular ring, as shown in the springs 30, 34 of FIGS. 1 and 3. In FIG. 1, the spring ends are connected at a weld 44, but alternative techniques for connecting spring ends exist in the art.

Unlike most springs, canted coil springs are compressible in a direction perpendicular to the spring axis, but only by force acting orthogonal to the plane or that imparts a orthogonal force to the plane in which the spring axis lies. This directional dependence results in two basic canted coil spring designs: radial springs 46, shown in FIG. 4, and axial springs 48, shown in FIG. 5. Radial springs 46 deflect in a radial direction perpendicular to the ring axis 50 (FIG. 3), whereas axial springs 48 deflect in an axial direction parallel to the ring axis 50. A ring axis 50, shown in FIG. 3, is defined as a theoretical axis that is at the center of the spring ring inside diameter and perpendicular to a spring axis 42.

Both radial and axial springs can also include a turn angle. A turn angle Θ, which is illustrated in FIG. 6, is the angle between the coil major axis 52 and the ring axis 50. More particularly, a spring ring whose coils 54 are rotated about the spring axis 42 at an angle relative to the normal position results in a turn angle Θ. The normal position for a radial spring coil 54, shown in dashed lines in FIG. 6, is generally with the spring ring major axis 52 parallel to the ring axis 50. The normal position for an axial spring coil (not shown) is generally with the spring ring major axis perpendicular to the ring axis 50. Furthermore, the spring ring is either concave or convex depending on the orientation of the turn angle. This feature allows for control of the insertion and running forces in a connector application.

Canted coil springs provide a variety of features and advantages for various applications. For example, the nearly constant force maintained by such springs over large deflections permits the design to function in high shock and vibration environments over wide temperature ranges. In addition, each coil of the spring acts independently. The coils can thus maintain multiple points of contact between mating surfaces to ensure excellent electrical conductivity. This arrangement also allows the spring to compensate for large mating tolerances, misalignments, and surface irregularities between mating surfaces. Further features of canted coil springs include, among others, low contact resistance, controllable insertion and removal force, heat dissipation, low and high current carrying capabilities, and availability in compact package sizes. Such features of canted coil springs are advantageous in a number of applications as discussed below.

The ability of canted coil springs to deflect and produce loads makes them well suited for latching, locking, holding, and compressing applications. Such applications can involve an axial spring, a radial spring, and/or a spring positioned at a turn angle. The spring acts as a connect mechanism between a housing and an insertion object of a connector assembly. The assembly configuration typically comprises a cavity or a groove in either the housing or the insertion object that holds the canted coil spring. The connection between the housing and the insertion object derives directly from the spring deflection.

Canted coil springs are also used for centering and aligning applications. For example, canted coil springs are used for centering seals around a shaft by adjusting for misalignment that may be present between the seal and the shaft. The spring can absorb different misalignments due to tolerances, tapering, and/or other irregularities while still maintaining sufficient sealing force.

Many applications for canted coil springs, including those described above, can leverage electrical conductivity of canted coil springs for electrical contact applications. In such applications, the canted coil springs are formed from spring wire that is made of a conductive material. Canted coil springs are well suited for electrical applications due in part to their ability to maintain numerous contact points with many coils that each act independently. Typical conductive materials used for such applications include copper and copper alloys, noble metals and noble metal alloys, aluminum and aluminum alloys, and silver.

Canted coil springs have also been used as spring energizers for sealing applications that require fluids to be confined within a space. The assembly configuration typically comprises a cavity within a seal, with the cavity retaining the canted coil spring. The canted coil spring provides uniform deflection around the periphery of the seal, which permits the spring to force the seal into contact with mating objects.

Canted coil springs are also advantageous in shielding and grounding applications. The springs can operate as EMI gaskets in applications that require suppression of external electromagnetic radiation, or containment of internal electromagnetic radiation. Canted coil spring EMI gaskets can provide effective shielding under conditions of high frequencies and high conductivity.

### SUMMARY

The various embodiments of the present multilayered canted coil springs and associated methods have several features, no single one of which is solely responsible for their desirable attributes. Without limiting the scope of the present embodiments as expressed by the claims that follow, their more prominent features now will be discussed briefly. After considering this discussion, and particularly after reading the section entitled “Detailed Description,” one will understand how the features of the present embodiments provide the advantages described herein.

One aspect of the present embodiments includes the realization that prior art canted coil springs are typically made of metal alloy spring wire. An alloy is a mixture of two or more metals selected to improve the material properties of the resulting alloy over any of the constituent parts alone. Metal alloys have greatly enhanced certain pure metal properties, but can still be limited. Limitations may include inadequate corrosion resistance, lack of biocompatibility, variable frictional force, stress relaxation, inability to operate at extreme temperatures, too much or too little conductivity, and lack of wear resistance. For example, because metal alloys are mixtures, the alloy may be less protected at its surface than one of the component metals would be alone.

One embodiment of the present methods comprises a method of forming a multilayered canted coil spring. The method comprises forming an inner core of a material having a first electrical conductivity. The method further comprises cladding or plating an outer layer of a material having a second electrical conductivity around the core to form a spring wire. The second electrical conductivity is less than the first electrical conductivity. The method further comprises forming the spring wire into a plurality of helical coils. The method further comprises canting the coils to form the canted coil spring.

Another embodiment of the present methods comprises a method of forming a multilayered canted coil spring. The method comprises forming an inner core of a material having a first electrical conductivity. The core is hollow. The method further comprises cladding or plating a secondary layer of a material having a second electrical conductivity around the core to form a spring wire. The second electrical conductivity is less than the first electrical conductivity. The method further comprises forming the spring wire into a plurality of helical coils. The method further comprises canting the coils to form the canted coil spring.

One embodiment of the present canted coil springs comprises a spring wire including a tubular shell surrounding a hollow core. The spring wire defines a plurality of helical coils. Each coil surrounds a spring axis that passes through a center of each coil. Each coil is tilted to lean at an angle relative to a line that is perpendicular to the spring axis.

One embodiment of the present multilayered canted coil springs comprises a spring wire including an inner core and an outer layer at least partially surrounding the core. The outer layer comprises two different and unmixed materials. A first one of the materials is disposed along a first portion of arc of a cross-section of the core. A second one of the materials is disposed along a second portion of arc of the core cross-section. The spring wire defines a plurality of helical coils. Each coil surrounds a spring axis that passes through a center of each coil. Each coil is tilted to lean at an angle relative to a line that is perpendicular to the spring axis.

### BRIEF DESCRIPTION OF THE DRAWINGS

The various embodiments of the present multilayered canted coil springs and associated methods now will be discussed in detail with an emphasis on highlighting the advantageous features. These embodiments depict the novel and non-obvious multilayered canted coil springs shown in the accompanying drawings, which are for illustrative purposes only. These drawings include the following figures, in which like numerals indicate like parts:

FIG. 1 is a front elevation view of a ring-shaped canted coil spring;

FIG. 2 is a front elevation view of a straight canted coil spring, illustrating the location of the spring axis in a canted coil spring;

FIG. 3 is a front perspective view of a ring-shaped canted coil spring, illustrating the location of the ring axis in a ring-shaped canted coil spring;

FIG. 4 is a front elevation view of a canted coil radial spring;

FIG. 5 is a side elevation view of a canted coil axial spring;

FIG. 6 is a cross-sectional side elevation view of a canted coil radial spring having a turn angle, with only a single coil shown for clarity;

FIG. 7A is a cross-sectional view of one embodiment of a multilayered wire configured for use in the present multilayered coil springs and associated methods;

FIG. 7B is a cross-sectional view of another embodiment of a multilayered wire configured for use in the present multilayered coil springs and associated methods;

FIG. 7C is a cross-sectional view of another embodiment of a multilayered wire configured for use in the present multilayered coil springs and associated methods;

FIG. 7D is a cross-sectional view of another embodiment of a multilayered wire configured for use in the present multilayered coil springs and associated methods;

FIG. 8A is a cross-sectional view of another embodiment of a multilayered wire configured for use in the present multilayered coil springs and associated methods;

FIG. 8B is a cross-sectional view of another embodiment of a multilayered wire configured for use in the present multilayered coil springs and associated methods;

FIG. 9 is a front perspective view of a canted coil spring in use as a spring energizer for a seal assembly;

FIG. 10A is a side partial cross-sectional view of a canted coil spring used as a connector between a shaft and a housing, illustrating one mounting configuration for the canted coil spring;

FIG. 10B is a side partial cross-sectional view of a canted coil spring used as a connector between a shaft and a housing, illustrating another mounting configuration for the canted coil spring;

FIGS. 11A and 11B are side partial cross-sectional views of a canted coil spring used in a holding application between a pin and a housing, illustrating the pin at pre-insertion (11A) and at full insertion (11B), wherein the canted coil spring is retained within a flat-bottomed groove in the housing;

FIGS. 12A and 12B are side partial cross-sectional views of a canted coil spring used in a holding application between a pin and a housing, illustrating the pin at pre-insertion (12A) and at full insertion (12B), wherein the canted coil spring is retained within a tapered-bottomed groove in the housing;

FIGS. 13A-13C are side partial cross-sectional views of a canted coil spring used in a latching application between a pin and a housing, illustrating the pin at pre-insertion (13A), during insertion (13B), and at full insertion (13C), wherein the canted coil spring is retained within a V-bottomed groove in the housing;

FIGS. 14A-14C are side partial cross-sectional views of a canted coil spring used in a locking application between a pin and a housing, illustrating the pin at pre-insertion (14A), during insertion (14B), and at full insertion (14C), wherein the canted coil spring is retained within a tapered-bottomed groove in the housing;

FIGS. 15A and 15B are side cross-sectional views of a canted coil spring used in a compression application between a base and a connecting part, illustrating the components pre-compression (15A) and post-compression (15B), wherein the canted coil spring is retained within a flat-bottomed groove in the base;

FIG. 16 is a side partial cross-sectional view of a canted coil spring used in a centering and aligning application between a seal and a shaft;

FIG. 17A is a front elevation view of a helical compression spring;

FIG. 17B is a front elevation view of a helical tension spring;

FIG. 17C is a front elevation view of a ribbon-type helical spring;

FIG. 18A is a side elevation view of a cantilever spring;

FIG. 18B is a front elevation view of the cantilever spring of FIG. 17A;

FIG. 19 is a front perspective view of two canted coil springs mounted in straight lengths on facing surfaces and configured for receiving a tab; and

FIG. 20 is a front elevation view of a section of a canted coil spring, illustrating an alternative mechanical joint between the spring ends without welding.

### DETAILED DESCRIPTION

The following detailed description describes the present embodiments with reference to the drawings. In the drawings, reference numbers label elements of the present embodiments. These reference numbers are reproduced below in connection with the discussion of the corresponding drawing features.

The embodiments of the present multilayered canted coil springs and associated methods are described below with reference to the figures. These figures, and their written descriptions, indicate that certain components of the apparatus are formed integrally, and certain other components are formed as separate pieces. Those of ordinary skill in the art will appreciate that components shown and described herein as being formed integrally may in alternative embodiments be formed as separate pieces. Those of ordinary skill in the art will further appreciate that components shown and described herein as being formed as separate pieces may in alternative embodiments be formed integrally. Further, as used herein the term integral describes a single unit or a unitary piece and whereas a unitary piece means a singularly formed single piece, such as a singularly formed mold or cast.

FIG. 7A illustrates a cross-sectional view of one embodiment of a spring wire 60 configured for use in the present multilayered canted coil springs. The spring wire 60 includes an inner core 62 surrounded by an outer layer 64. In the illustrated embodiment, the outer layer 64 completely surrounds the core 62 with no intervening layer(s). The core 62 comprises a first material composition, and the outer layer 64 comprises a second material composition. In alternative embodiments the outer layer 64 may not completely surround the core 62, leaving a portion or portions of the core 62 exposed.

In one embodiment, the core 62 may comprise a highly electrically conductive metal, such as copper or a copper alloy, and the outer layer 64 may comprise a material having a high mechanical property, such as a higher tensile strength property than the inner core, but a lower electrical conductivity than the core 62. In one example, the outer layer is steel or stainless steel. This embodiment is well suited for applications involving electrical conductivity in high temperature environments. The copper provides high electrical conductivity while the stainless steel provides a protective outer shield having advantageous mechanical properties. For example, the stainless steel outer layer 64 is better able to maintain tensile strength properties, and thus spring force, as compared to the copper core 62. Further, the stainless steel outer layer 64 is better able to withstand ambient conditions, such as temperature extremes and/or corrosive agents. The stainless steel outer layer 64 thus protects the copper core 62 from ambient conditions, enabling the spring 60 to retain its electrically conductive properties even under harsh conditions. For example, the strength of stainless steel degrades at much higher temperatures than that of copper, making the spring wire 60 effective for conductive applications at higher temperatures as compared to a copper wire with no stainless steel outer layer 64. The stainless steel outer layer 64, even though less conductive than copper and copper alloys, is still electrically conductive so that the outer layer 64 may conduct current through to the copper core 62 to maintain effective electrical conductivity in the spring wire 60, as further discussed below. The net result is that the canted coil spring wire 60 provides reliable electrical conductivity while lasting longer, being capable of operating at higher temperatures, and providing greater corrosion resistance. In other embodiments, the inner core is made from a different conductive metal, such as noble metals and noble metal alloys, aluminum and aluminum alloys, and silver.

In addition, the material compositions described above can improve stress relaxation of the canted coil spring wire 60, especially at elevated temperatures. Certain metals such as copper alloys and aluminum alloys create undesirable spring deformation due to stress variations when subjected to elevated temperatures. At such conditions, spring coils made from these materials tend to have dimensional variations such as altering of the spring coil angle, spring coil cross-section, and spring rotation, which affects the overall spring performance significantly. To reduce or eliminate undesirable spring deformation, the spring wire 60 may comprise a core 62 of a highly electrically conductive metal, such as copper, copper alloy, aluminum, or aluminum alloy, and an outer layer 64 of a material having a high mechanical property, but a lower electrical conductivity than the core 62, such as steel or stainless steel.

In other applications, such as where corrosion resistance is important, the outer layer 64 may comprise a corrosion-resistant metal, such as certain stainless steels. The outer layer 64 thus resists oxidation of the spring wire 60, protecting the core 62, which may be more susceptible to corrosion. Corrosion resistance can be a vital factor in many applications, such as those in acidic environments, harsh environments, and conductive applications. For example in a conductive application in a harsh environment, corrosion resistance can maintain sufficient conductivity by reducing oxidation at the contact surface area, thus allowing better current flow through such contact area for better overall conduction.

In other applications, the present springs may comprise materials that provide galvanic corrosion resistance. Galvanic corrosion is an electrochemical process in which one metal corrodes preferentially when in electrical contact with a different type of metal and both metals are immersed in an electrolyte. For example, beryllium copper and carbon steel are not galvanic compatible. Therefore a beryllium copper coil spring will corrode in an application requiring mounting within a carbon steel housing, especially if deployed in a harsh environment. However, tin is galvanic compatible with carbon steel. Thus, in an application with a carbon steel housing, a spring wire 60 comprising a beryllium copper core 62 and a tin outer layer 64 can be used to reduce or prevent corrosion by preventing contact between the beryllium copper core 62 and the carbon steel housing.

In other applications, the present springs may comprise materials that provide biocompatibility. Biocompatibility is desirable for applications such as implantable devices or medical devices. In such applications, the core 62 may comprise copper or a copper alloy while the outer layer 64 may comprise titanium so that the human body does not reject an implant or otherwise react adversely to a medical device.

FIG. 7B illustrates a cross-sectional view of another embodiment of a spring wire 70 configured for use in the present multilayered canted coil springs. Again, the spring wire 70 includes an inner core 72 surrounded by an outer layer 74. As in the embodiment of FIG. 7A, the core 72 may comprise copper or a copper alloy and the outer layer 74 may comprise steel or stainless steel. However, in FIG. 7B the thickness of the outer layer 74 is increased relative to the embodiment of FIG. 7A. By varying the thickness of the core 72 and/or the outer layer 74, and/or varying the relative cross-sectional area percentages of the core 72 and the outer layer 74, properties of the spring wire 70 can be tailored to suit different applications.

FIG. 7C illustrates a cross-sectional view of another embodiment of a spring wire 80 configured for use in the present multilayered canted coil springs. Again, the spring wire 80 includes an inner core 82 surrounded by an outer layer 84. However, the embodiment of FIG. 7C further includes an intermediate layer 86 surrounding the core 82 and beneath the outer layer 84. The three layers 82, 84, 86 may be varied in material composition and/or relative thickness and/or relative cross-sectional area percentages in order to tailor the properties of the spring wire 80 to suit different applications. For example, in some embodiments the three layers 82, 84, 86 may have three different material compositions. In other embodiments, the core 82 and the outer layer 84 may have the same composition, while the intermediate layer 86 has a composition different from the core 82 and the outer layer 84. As in the previous embodiments, the thicknesses and/or relative cross-sectional area percentages of the core 82 and/or the outer layer 84 may be tailored to provide the spring wire 80 with desired physical properties such as conductivity, temperature resistance, corrosion resistance, galvanic corrosion reduction, friction, spring hardness, etc. In one embodiment, the core 82 may comprise copper or a copper alloy, the intermediate layer 86 may comprise steel or stainless steel, and the outer layer 84 may comprise silver. The silver outer layer 84 improves electrical conductivity and lowers friction.

FIG. 7D illustrates a cross-sectional view of another embodiment of a spring wire 90 configured for use in the present multilayered canted coil springs. Again, the spring wire 90 includes an inner core 92 surrounded by an outer layer 94. However, in the embodiment of FIG. 7D the outer layer 94 is not unitary. Rather, the outer layer 94 includes a first portion 96 and a second portion 98. The first portion 96 is disposed along a first portion of arc of the spring wire cross-section, and the second portion 98 is disposed along a second portion of arc of the spring wire cross-section. In the illustrated embodiment, the first and second portions of arc are both 180°. However, in alternative embodiments each portion of arc could have any magnitude. And in yet further alternative embodiments, the outer layer 94 may have more than two portions, such as three portions, four portions, or any number of portions. Further, the outer layer 94 may not completely surround the core 92.

In the embodiment of FIG. 7D, the various portions of the outer layer 94 may have differing material compositions or the same composition. For example, the inner core 92 may comprise a conductive material, such as copper, copper alloy, aluminum, aluminum alloy, gold, gold alloy, silver, silver alloy, brass, or brass alloy, and the outer layer may comprise different stainless steel along different outer portions, the same stainless steel along different outer portions, or different high tensile strength materials along different outer portions.

The drawings in the present application are not to scale. Thus, for example, the relative thicknesses of the layers shown in FIGS. 7A-7D are not limiting.

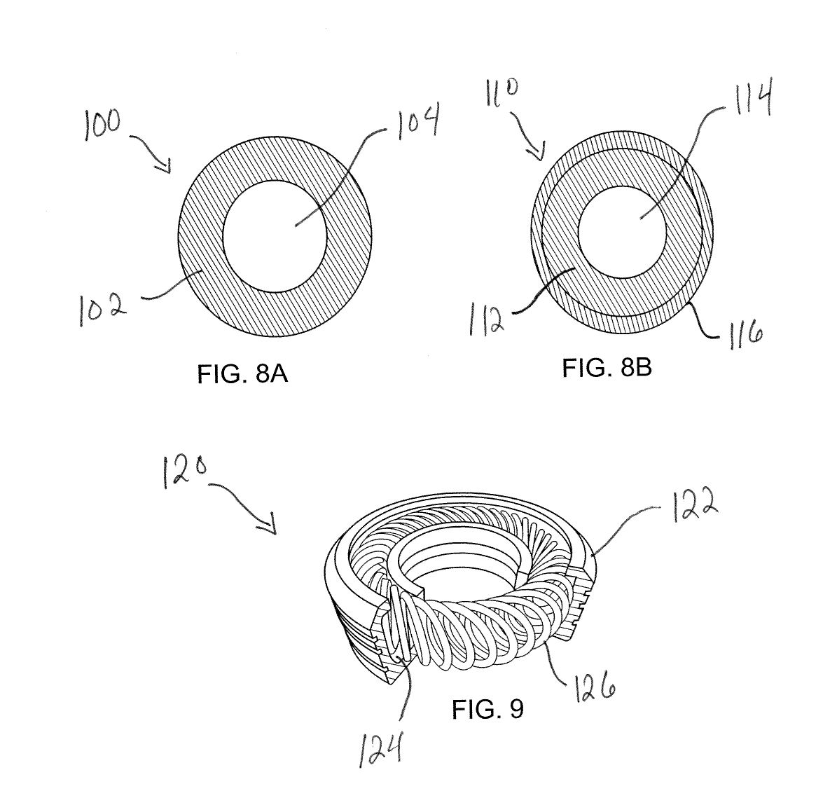

FIG. 8A illustrates a cross-sectional view of another embodiment of a spring wire 100 configured for use in the present multilayered canted coil springs. The spring wire 100 comprises a tubular shell 102 surrounding a hollow core 104. As used herein, the term multilayered is construed broadly enough to cover the wire of FIG. 8A, which has a single layer 102 surrounding a hollow core 104.

FIG. 8B illustrates a cross-sectional view of another embodiment of a spring wire 110 configured for use in the present multilayered canted coil springs. Again, the spring wire 110 comprises a tubular shell 112 surrounding a hollow core 114. However, in the embodiment of FIG. 8B the spring wire 110 further comprises an outer layer 116 surrounding the tubular shell 112. The outer layer 116 may have a material composition different from that of the tubular shell 112. As in the previous embodiments, the material composition of the outer layer 116 can be selected to provide desired mechanical properties, such as conductivity, corrosion resistance, galvanic compatibility, friction, etc.

The embodiments of FIGS. 8A and 8B are well suited to applications which the material of the tubular shell 102, 112 is a highly thermally conductive metal, such as copper. The hollow core 104, 114 can be partially or completely filled with a working fluid that aids thermal conduction of latent heat from a first mating object to a second mating object through the spring. The composition of the working fluid(s) can vary depending upon various parameters of the application, such as the operational temperature range. Example working fluids include water, ethanol, acetone, sodium, mercury, or any other fluid. Likewise, the composition of the tubular shell 102, 112 and/or the outer layer 116 can vary depending upon various parameters of the application. For example, the outer layer 116 can be selected depending on the desired conductivity, corrosion resistance, galvanic compatibility, friction, etc.

In another embodiment, the hollow spring wires 100, 110 of FIGS. 8A and 8B are configured for phase change cooling similar to a heat pipe design. A heat pipe is a heat transfer mechanism that can transport large quantities of heat from a hot body to a cool body with a very small difference in temperature. The hot body heats a first end of the pipe, the hot end. As liquid evaporates at the hot end of the heat pipe, it naturally carries heat to the cool end, where it condenses and then returns to the hot end. The condensing fluid transfers heat to the cool body.

A canted coil spring with a hollow core can advantageously act as a sealed pipe in a canted coil spring heat pipe. To produce such a heat pipe, the hollow core 104, 114 of the spring is evacuated and a working fluid is added to partially fill the hollow core 104, 114. For example, the core 104, 114 may be filled to approximately 30%-40% of its total volume. The spring wire 100, 110 is then sealed. The resulting canted coil spring heat pipe provides an effective heat transfer mechanism with no moving parts. In certain applications the canted coil spring heat pipe can also act as a mechanical connector between the hot and cool bodies, so that the spring heat pipe serves the dual purposes of connecting and cooling.

TABLE I

| | | | | | | Conductivity |
|---|---|---|---|---|---|---|
| | | | | | | (% IACS)¹, |
| | Test | % Area | % Area | Resistance/ | Resistivity % | base value of pure |
| Material | No. | Copper | S.S. | ft. (Ω/ft.) | Ω-cmil/ft | copper at 100 |
| Be—Cu | 1 | N/A | N/A | 0.241 | 61.74 | 16.80 |
| 25 C17200 | 2 | | | 0.239 | 61.27 | 16.93 |
| Zr—Cu Chrome | 1 | N/A | N/A | 0.066 | 16.78 | 61.80 |
| | 2 | | | 0.064 | 16.47 | 62.98 |
| 1045 Carbon | 1 | N/A | N/A | 0.096 | 24.59 | 42.18 |
| Steel w/Cu | 2 | | | 0.097 | 24.82 | 41.79 |
| Cladding | | | | | | |
| 316 S.S. w/Cu | 1 | 44% | 56% | 0.116 | 29.58 | 35.06 |
| Cladding | 2 | | | 0.115 | 29.42 | 35.25 |
| Cu w/304 S.S. | 1 | 60% | 40% | 0.067 | 17.09 | 60.68 |
| Cladding | 2 | | | 0.065 | 16.70 | 62.09 |
| Cu w/304 S.S. | 1 | 58% | 42% | 0.065 | 16.59 | 62.53 |
| Cladding | | | | | | |
| Cu w/304 S.S. | 1 | 62% | 38% | 0.066 | 17.01 | 60.98 |
| Cladding | 2 | | | 0.066 | 16.84 | 61.57 |
| Cu w/304 S.S. | 1 | 58% | 42% | 0.066 | 16.78 | 61.80 |
| Cladding | | | | | | |

¹IACS—International Annealed Copper Standard, a unit of electrical conductivity for metals and alloys relative to a standard annealed copper conductor. An IACS value of 100% refers to a conductivity of 5.80 × 10⁷ siemens per meter (58.0 MS/m).

Table I, above, demonstrates unexpected results achieved by the present embodiments having a copper core and a stainless steel outer layer. For example, Table I indicates that the conductivity of a spring wire having a copper core and a stainless steel outer layer (60-63% IACS) is greater than the conductivity of a spring wire having a stainless steel core and a copper outer layer (˜35% IACS). This result is the opposite of what one would expect, because when copper is on the outside of the multilayer spring wire, current is believed to readily conduct as there is no outer obstructions and therefore should provide higher conductivity. By contrast, when copper is on the inside of the multilayer spring wire, it is shielded by the lower conductivity stainless steel outer layer yet the results show a better conducting wire than when copper is on the outside. For example, to pass through the higher conductivity copper core, current must first pass through the lower conductivity stainless steel outer layer in order to reach the copper. It is thus surprising that the conductivity of the spring wire having a copper core and a stainless steel outer layer is actually greater than the conductivity of the spring wire having a stainless steel core and a copper outer layer. In fact, the spring wire having a copper core and a stainless steel outer layer provides at least 50% the conductivity of pure copper while the reversed configuration provides only about 42% the conductivity of pure copper. For example, a wire having a conductive layer as an inner core and a higher tensile strength material as an outer layer can provide more than 55% of the conductivity of pure copper, such as at least 60% and at least 62%. These surprising results allow a designer to incorporate canted coil springs discussed herein in high temperature electrical applications, such as battery terminals, while ensuring, mechanical integrity, such as resisting hot flow, yielding, and deformation.

FIGS. 9-20 illustrate various applications for the present canted coil springs. These applications are not intended to be exhaustive. A variety of additional applications currently exist, and many more may be later developed. The following examples should not be interpreted as limiting.

FIG. 9 illustrates an embodiment of the present canted coil springs used as a spring energizer for a ring-shaped seal assembly 120. The assembly 120 may, for example, be disposed about a cylindrical shaft (not shown). In the assembly 120, the seal 122 includes an annular cavity 124 that receives and retains the spring 126. The canted coil spring 126 provides uniform deflection around the periphery of the seal 122, permitting the spring 126 to force the seal 122 into contact with mating objects. The material composition of the outer layer of the spring 126 can be tailored to provide, for example, biocompatibility, galvanic compatibility, and/or corrosion resistance with respect to the working fluid to which the seal 122 is exposed.

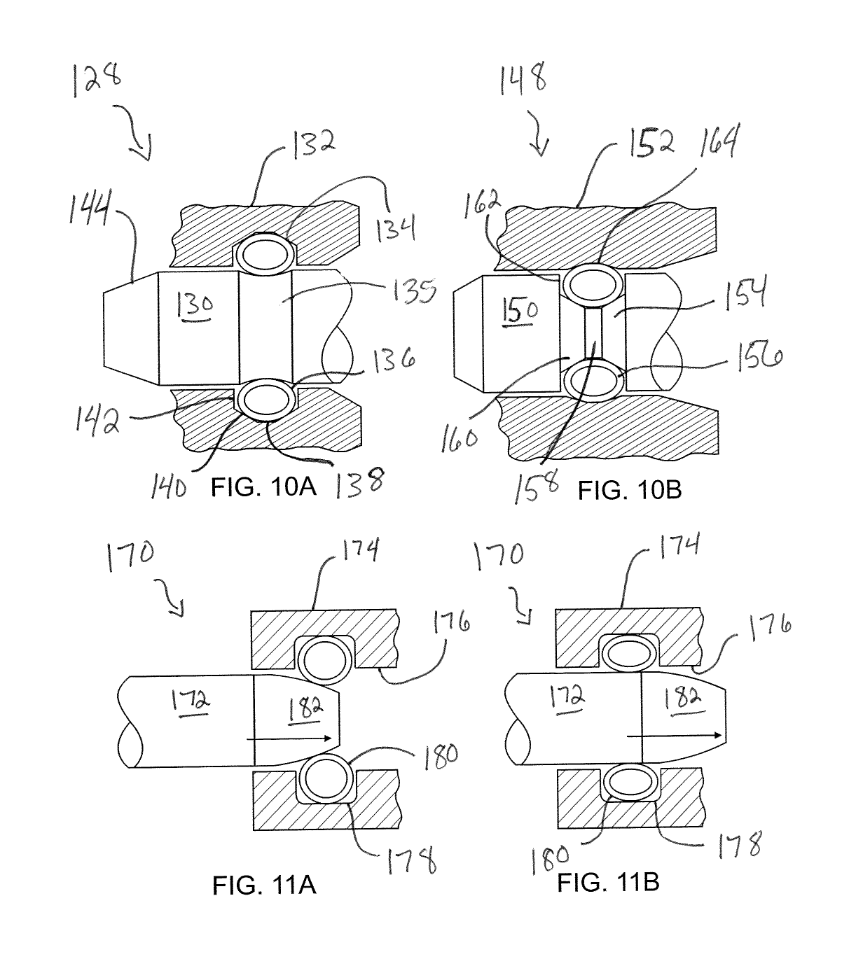

FIG. 10A is a side partial cross-sectional view of an embodiment of the present canted coil springs used as a connector 128 between a shaft 130 and a housing 132. The housing 132 includes an annular groove 134 that receives and retains the spring 136. In the illustrated embodiment, the annular groove 134 in the housing 132 includes a flat bottom 138 having tapered walls 140 connecting the bottom 138 to sidewalls 142 that are perpendicular to the longitudinal axis of the shaft 130. In an at rest configuration, prior to insertion of the shaft 130, an interior diameter of the spring 136 is somewhat less than an exterior diameter of the shaft 130. The shaft 130 is inserted into the housing 132 in the axial direction with the tapered end 144 leading. The spring 136 deforms as it expands to accommodate the diameter of the shaft 130. Eventually, the spring 136 relaxes somewhat as it settles into the shallow annular groove 135 in the shaft 130. The exterior diameter of the annular groove 135 in the shaft 130 is greater than the interior diameter of the spring 136 in the at rest configuration. The spring force exerted by the spring 136 against the shaft 130 and the housing 132 thus resists withdrawal of the shaft 130 from the housing 132. In another embodiment, one of the sidewalls 142 is tapered, i.e., at an angle that is not 90 degrees to the axis of the shaft. This allows the shaft 130 to be removed, such as withdrawn from the housing, in the direction of the tapered sidewall easier than in the direction of the perpendicular sidewall.

FIG. 10B is a side partial cross-sectional view of another embodiment of the present canted coil springs used as a connector 148 between a shaft 150 and a housing 152. The shaft 150 includes an annular groove 154 that receives and retains the spring 156. In the illustrated embodiment, the groove 154 is relatively deep, and includes a flat bottom 158 having tapered walls 160 connecting the bottom 158 to sidewalls 162 that are perpendicular to the longitudinal axis of the shaft 150. In an at rest configuration, prior to insertion of the shaft 150, an exterior diameter of the spring 156 is somewhat greater than an interior diameter of the housing 152. The shaft 150 is inserted into the housing 152 in the axial direction. The spring 156 deforms as it compresses to accommodate the interior diameter of the housing 152. Eventually, the spring 156 relaxes somewhat as it settles into the shallow annular groove 164 in the housing 152. The diameter of the annular groove 164 in the housing 152 is smaller than the exterior diameter of the spring 156 in the at rest configuration. The spring force exerted by the spring 156 against the shaft 150 and the housing 152 thus resists withdrawal of the shaft 150 from the housing 152. In another embodiment, at least one of the sidewalls 162 is tapered, i.e., not perpendicular to the axis of the shaft 150.

In one application, the connectors 128, 148 of FIGS. 10A and 10B may comprise an electrical connector, with the canted coil spring 136, 156 conducting current between the housing 132, 152 and the shaft 130, 150. The spring materials can be tailored as described above to be effective in diverse environments and conditions, including extreme temperatures, acidic environments, etc. In one embodiment, the spring is a multi-metallic spring comprising a conductive inner core and a relatively higher tensile strength outer layer. For example, the spring can have a copper or copper alloy inner core and an outer stainless steel layer.

FIGS. 11A and 11B are side partial cross-sectional views of an embodiment of the present canted coil springs used as a connector 170 between a pin 172 and a housing 174. The housing 174 includes a bore 176 with an internal flat-bottom groove 178. However, the internal groove 178 may comprise any cross-sectional shape, such as a V-bottom groove or a tapered-bottom groove. A canted coil spring 180, such as a radial canted coil spring, is disposed in the flat-bottom groove 178. The pin 172 is cylindrical and includes a tapered nose 182 for insertion into the housing bore 176. FIG. 11A shows a preassembled position where the pin 172 is being inserted into the housing 174. FIG. 11B shows the assembled position. In an at rest configuration, prior to insertion of the pin 172, an interior diameter of the spring 180 is somewhat less than an exterior diameter of the pin 172. The pin 172 is inserted into the housing 174 in the axial direction with the tapered nose 182 leading. The spring 180 deforms as it expands to accommodate the diameter of the pin 172. The spring force exerted by the spring 180 against the pin 172 and the housing 174 resists withdrawal of the pin 172 from the housing 174.

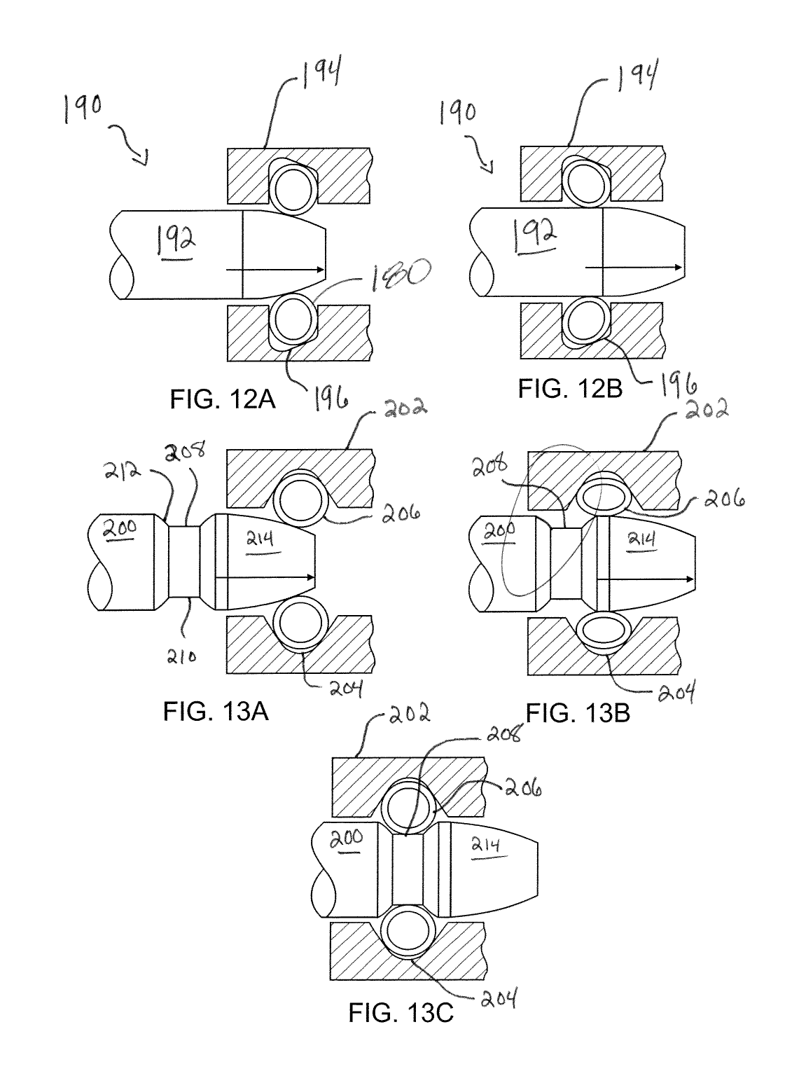

FIGS. 12A and 12B are side partial cross-sectional views of another embodiment of the present canted coil springs used as a connector 190 between a pin 192 and a housing 194. The embodiment of FIGS. 12A and 12B is similar to the embodiment of FIGS. 11A and 11B, except that the groove 196 in the housing 194 includes a tapered bottom. The tapered bottom groove causes the spring 180 to rotate so that its major axis is no longer parallel with the axis of the shaft.

FIGS. 13A-13C are side partial cross-sectional views of another embodiment of the present canted coil springs used in a latching application for a pin 200 and a housing 202. The housing 202 includes an annular groove 204 that receives and retains the spring 206. In the illustrated embodiment, the annular groove 204 in the housing 202 is V-shaped. The pin 200 also includes an annular groove 208. The pin groove 208 includes a flat bottom 210 having tapered walls 212 extending from the bottom 210 to the outer surface of the pin 200 (FIG. 13A). The pin 200 includes a tapered nose 214. In an at rest configuration, prior to insertion of the pin 200, an interior diameter of the spring 206 is somewhat less than a maximum exterior diameter of the pin 200, but substantially equal to the exterior diameter of the pin 200 at the base 210 of the groove 204. The pin 200 is inserted into the housing 202 in the axial direction with the tapered nose 214 leading (FIG. 13A). The spring 206 deforms as it expands to accommodate the diameter of the pin 200 (FIG. 13B). Eventually, the spring 206 relaxes as it settles into the annular groove 208 in the pin 200 (FIG. 13C). The tapered sidewalls 212 of the pin groove 208 cause the spring force exerted on the pin 200 and the housing 202 to increase if the pin 200 moves axially. The spring 206 thus resists withdrawal of the pin 200 from the housing 202. The spring 206, like other springs discussed elsewhere herein, is made from a multi-metallic wire. Preferably, the spring has an inner core made of a conductive material and an outer layer may of a high tensile strength steel. As an example, the inner core may be made from copper, copper alloy, aluminum, aluminum alloy, gold, gold alloy, silver, silver alloy, brass, or brass alloy, and the outer layer may be made from steel or stainless steel.

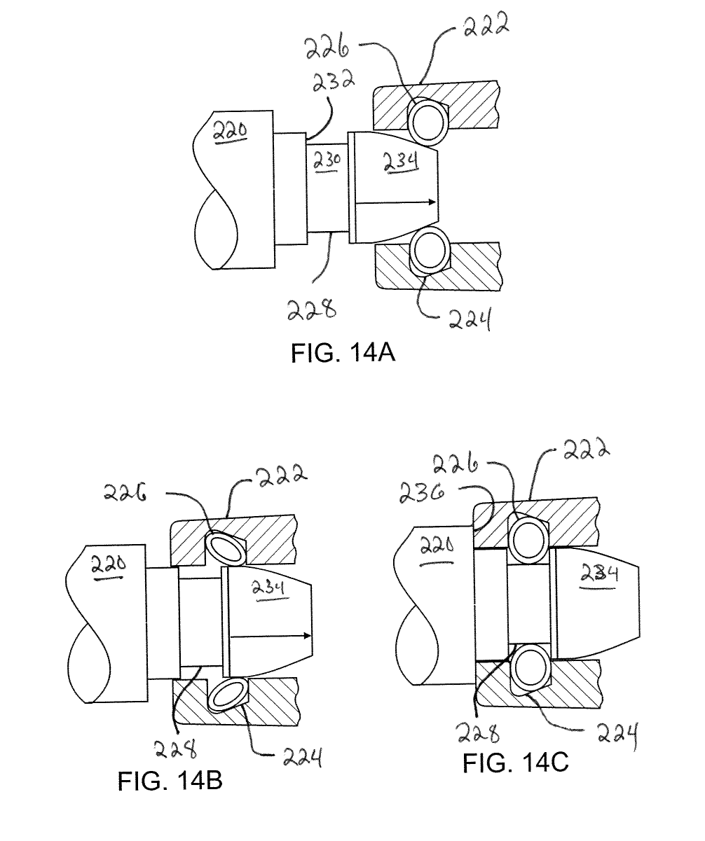

FIGS. 14A-14C are side partial cross-sectional views of another embodiment of the present canted coil springs used in a locking application for a pin 220 and a housing 222. The housing 222 includes an annular groove 224 that receives and retains the spring 226. In the illustrated embodiment, the annular groove 224 in the housing 222 has a tapered bottom. The pin 220 also includes an annular groove 228. The pin groove 228 includes a flat bottom 230 with sidewalls 232 that are perpendicular to the longitudinal axis of the pin 220 (FIG. 14A). The pin 220 includes a tapered nose 234. In an at rest configuration, prior to insertion of the pin 220, an interior diameter of the spring 226 is somewhat less than a maximum exterior diameter of the pin 220, but substantially equal to the exterior diameter of the pin 220 at the groove 230. The pin 220 is inserted into the housing 222 in the axial direction with the tapered nose 234 leading (FIG. 14A). The spring 226 deforms as it expands to accommodate the diameter of the pin 220 (FIG. 14B). Eventually, the spring 226 relaxes as it settles into the annular groove 230 in the pin 220 (FIG. 14C). As the spring 226 reaches the pin groove 230, an annular shoulder 236 on the pin 220 abuts the housing 222. The sidewalls 232 of the pin groove 230, which are perpendicular to the longitudinal axis of the pin 220, prevent withdrawal of the pin 220 from the housing 222. Again, the spring 226 is preferably made from a multi-metallic wire. For example, the inner core may be made from copper, copper alloy, aluminum, aluminum alloy, gold, gold alloy, silver, silver alloy, brass, or brass alloy, and the outer layer may be made from steel or stainless steel.

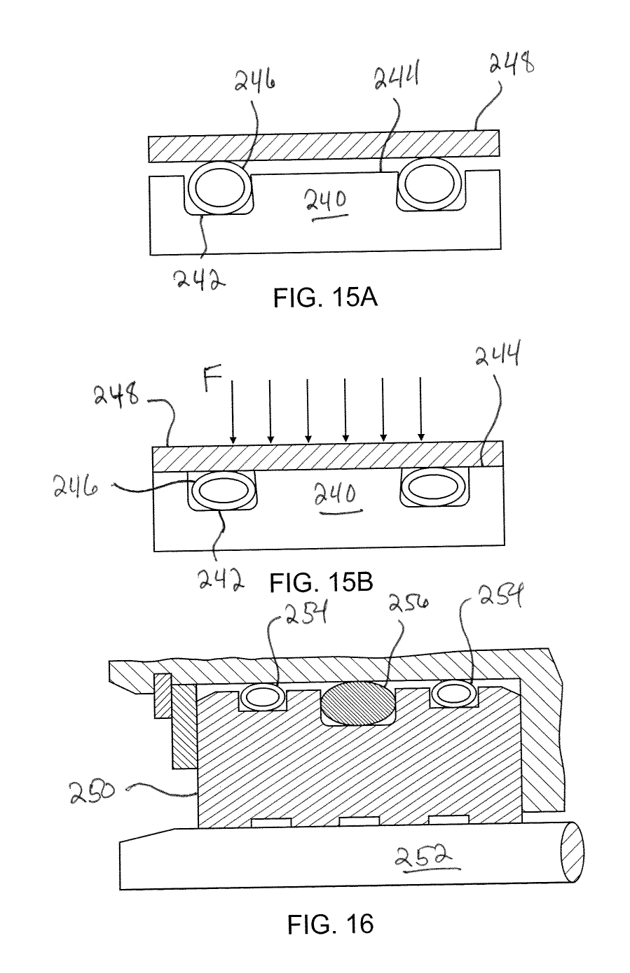

FIGS. 15A and 15B are side partial cross-sectional views of another embodiment of the present canted coil springs used in a compression application. The embodiment includes a base 240 with a circular flat-bottom groove 242 in one surface 244. A circular canted coil spring 246 is disposed in the groove 242. A compression force F forces a connecting part 248 against the surface 244 (FIG. 15B), compressing the spring 246 within the groove 242. The spring 246 may be axially or radially canted. In alternative embodiments, grooves having different bases, such as V-bottom or tapered-bottom, may be used. In perspective view, the groove 242 may comprise a generally circular boundary having a central section 240. In other embodiments, the groove 242 may comprise a generally rectangular boundary, a generally oval boundary, or a generally square boundary. In still other embodiments, the groove 242 is not interconnected, such as two generally parallel grooves, or is not a closed loop, such as a U-shape boundary.

FIG. 16 is a side partial cross-sectional view of another embodiment of the present canted coil springs used in a centering and aligning application for a seal 250 and a shaft 252. The embodiment forms a spring-loaded clearance seal in which two circular radial springs 254, loaded along the minor axis of each, maintain the inside diameter of the seal 250 concentric with the shaft 252. In addition, an O-ring 256 provides a static sealing on the outside diameter of the seal 250. The clearance seal 250 controls the flow of fluids between the inside diameter of the seal 250 and the shaft 252. The radial canted coil springs 254 have sufficient force to prevent the seal 250 from rotating and still maintain sufficient force to absorb eccentricities and irregularities caused by misalignment that may occur on the shaft 252. Again, the spring 254 is preferably made from a multi-metallic wire. For example, the inner core may be made from copper, copper alloy, aluminum, aluminum alloy, gold, gold alloy, silver, silver alloy, brass, or brass alloy, and the outer layer may be made from steel or stainless steel.

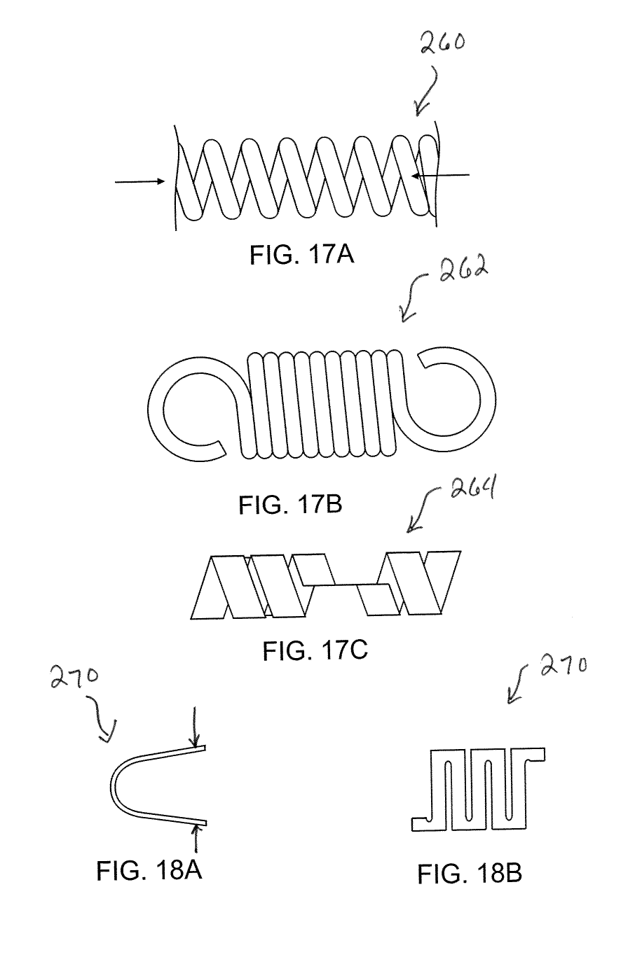

FIGS. 17A-17C are side elevation views of embodiments of the present springs not having canted coils. FIG. 17A is a helical compression spring 260 with the ability to compress to a smaller length under a compressive load or stretched under a tensile load. FIG. 17B is a helical tension spring 262 with the ability to extend to a longer length under a tensile load. FIG. 17C is a ribbon-type helical spring 264, which has a similar function as a compression or extension spring. However, the spring wire of the ribbon-type helical spring 264 is a flat, rectangular band, rather than a wire having a round cross-section.

FIG. 18A is an end view, and FIG. 18B is a side elevation view of a cantilever spring 270. The cantilever spring 270 can be compressed radially, as shown in FIG. 18A, due to its V-shape in end view. The spring return force created by the applied compressive force can be used to urge a seal against a surface, such as in a shaft sealing application. The cantilever spring 270 can either be a spring length or welded into a spring ring. The springs of FIGS. 17A-18B may be made from a multi-metallic coil or ribbon. For example, the multi-metallic coil or ribbon may have an inner core, or inner layer for a ribbon, made from copper, copper alloy, aluminum, aluminum alloy, gold, gold alloy, silver, silver alloy, brass, or brass alloy, and an outer layer made from steel or stainless steel.

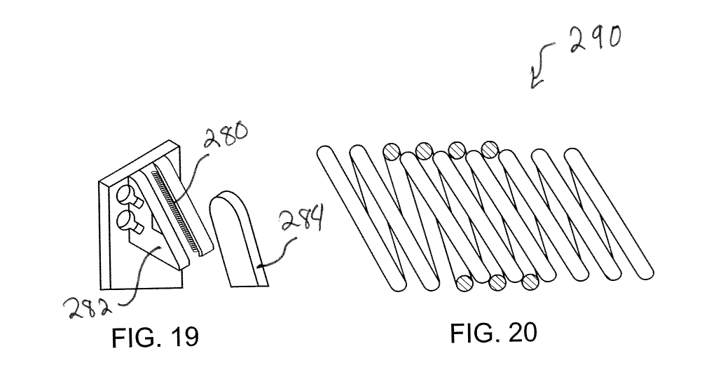

FIG. 19 is a perspective view of two canted coil springs 280 (one visible) having straight lengths where the ends of each spring 280 are not connected. The springs 280 are mounted in a housing 282 and receive a flat connector 284 in a compression fit. As shown, the springs 280 are incorporated in a knife-edge contact and the assembly may be referred to as a knife-edge connector.

Any of the foregoing springs may comprise the material compositions described herein. Further, the spring coil of the present canted coil springs may embody various cross-sectional shapes. For example, the spring coil may have a cross-sectional shape of a circle, an oval, a square, a rectangle, a triangle, or any other shape. By varying the shape of the spring coil, the contact area between the spring coil and the housing or the insertion object may be controlled. Examples of various canted coil spring designs may be found in U.S. Pat. No. 7,055,812, which is expressly incorporated herein by reference in its entirety.

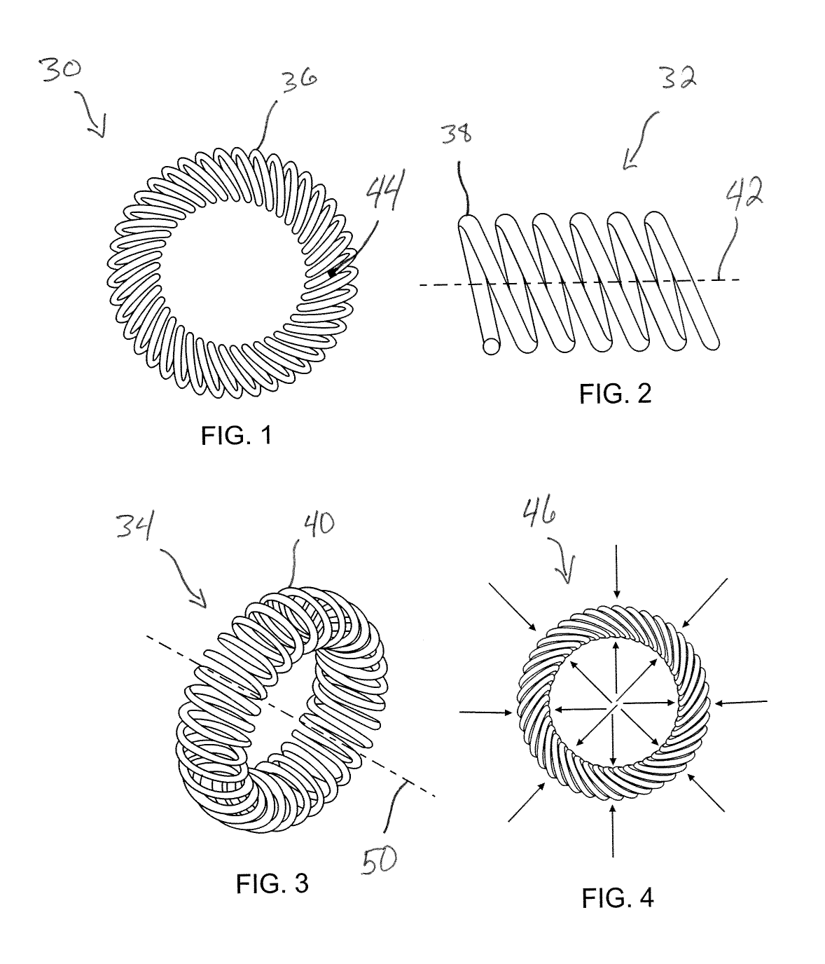

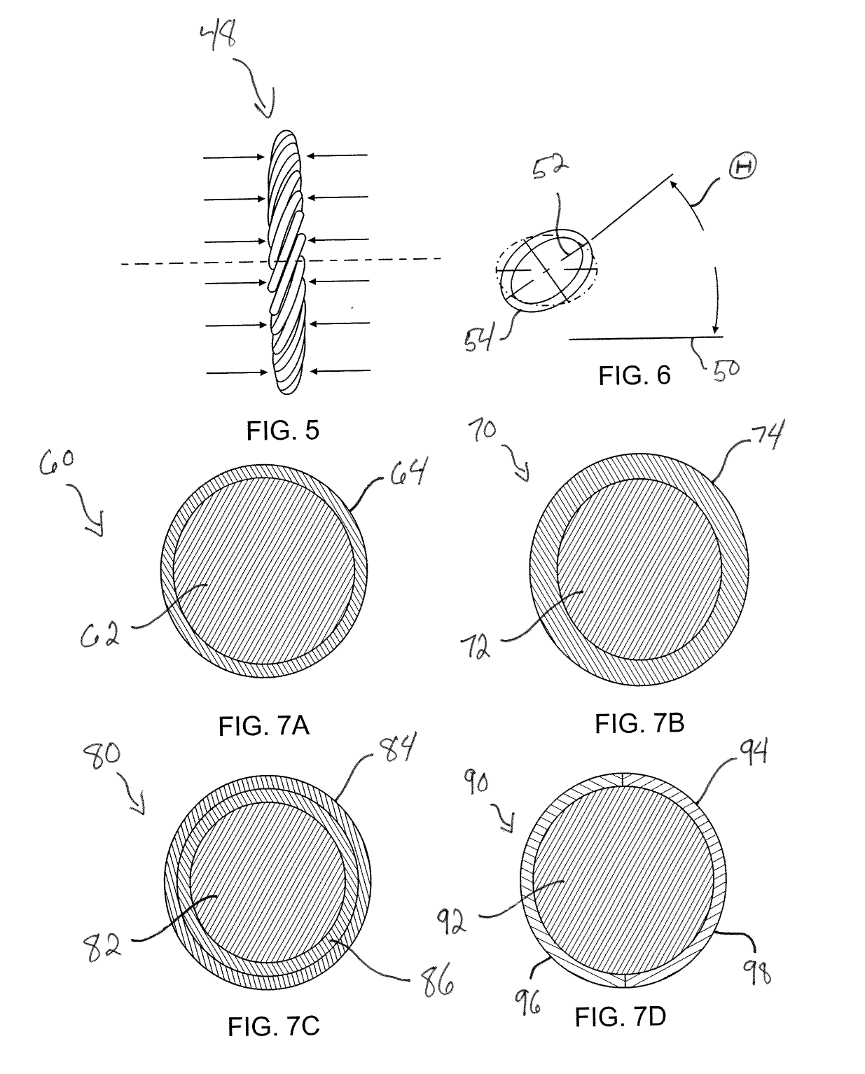

The ends of the present canted coil springs may be mechanically joined together with a weld, such as the weld 44 shown in FIG. 1. Alternatively, the ends of the present canted coil springs may be mechanically joined together without welding. For example, the spring ends may be held together by a snap action, threading, straight push, or a combination twist and push. For example, in the canted coil spring 290 of FIG. 20 the spring ends are mechanically joined with circular intermediate coils with circular snap-on end coils. Examples of various techniques for joining the ends of canted coil springs are shown in U.S. Pat. No. 5,791,638, which is expressly incorporated herein by reference in its entirety.

In several of the above embodiments, the present canted coil springs are shown disposed within grooves in housings and/or shafts. Many of these grooves have different cross-sectional shapes. However, none of the illustrated groove shapes is limiting. The present canted coil springs are configured for use with grooves of any shape.

The above description presents the best mode contemplated for carrying out the present multilayered canted coil springs and associated methods, and of the manner and process of making and using them, in such full, clear, concise, and exact terms as to enable any person skilled in the art to which it pertains to make and use these springs and associated methods. These springs and associated methods are, however, susceptible to modifications and alternate constructions from that discussed above that are fully equivalent. Consequently, these springs and associated methods are not limited to the particular embodiments disclosed. On the contrary, these springs and associated methods cover all modifications and alternate constructions coming within the spirit and scope of the springs and associated methods as generally expressed by the following claims, which particularly point out and distinctly claim the subject matter of the springs and associated methods.

What is claimed is:

1. A method of forming a multilayered canted coil spring, comprising:
forming an inner core of a material having a first electrical conductivity;
cladding or plating an outer layer of a material having a second electrical conductivity around the core to form a spring wire, the second electrical conductivity being less than the first electrical conductivity;
forming the spring wire into a plurality of helical coils; and
canting the coils to form the canted coil spring.

2. The method of claim 1, wherein the inner core comprises copper or a copper alloy and the outer layer comprises stainless steel.

3. The method of claim 1, wherein the core is hollow.

4. The method of claim 3, wherein the hollow core contains a fluid.

5. The method of claim 4, wherein the fluid enables phase-change cooling.

6. The method of claim 4, wherein the fluid is water, ethanol, acetone, sodium, or mercury.

7. The method of claim 1, wherein the spring has a conductivity that is at least 50% the conductivity of pure copper.

8. The method of claim 2, wherein the spring is positioned in a groove comprising a groove bottom and two sidewalls.

9. A method of forming a multilayered canted coil spring, comprising:
forming an inner core of a material having a first electrical conductivity, the core being hollow;
cladding or plating a secondary layer of a material having a second electrical conductivity around the core to form a spring wire, the second electrical conductivity being less than the first electrical conductivity;
forming the spring wire into a plurality of helical coils; and
canting the coils to form the canted coil spring.

10. The method of claim 9, wherein the inner core comprises copper or a copper alloy and the secondary layer comprises stainless steel.

11. The method of claim 10, wherein the hollow core contains a fluid.

12. The method of claim 11, wherein the fluid enables phase-change cooling.

13. The method of claim 11, wherein the fluid is water, ethanol, acetone, sodium, or mercury.

14. The method of claim 10, wherein the spring has a conductivity that is at least 50% the conductivity of pure copper.

15. A canted coil spring, comprising:
a spring wire including a tubular shell surrounding a hollow core, the spring wire defining a plurality of helical coils, each coil surrounding a spring axis that passes through a center of each coil, each coil being tilted to lean at an angle relative to a line that is perpendicular to the spring axis.

16. The spring of claim 15, wherein the hollow core contains a fluid.

17. The method of claim 16, wherein the fluid enables phase-change cooling.

18. The method of claim 16, wherein the fluid is water, ethanol, acetone, sodium, or mercury.

19. The spring of claim 15, further comprising an outer layer at least partially surrounding the core.

20. The spring of claim 15, wherein the core comprises a material having a first electrical conductivity, the outer layer comprises a material having a second electrical conductivity, and the second electrical conductivity is less than the first electrical conductivity.

21. The spring of claim 20, wherein the core comprises copper or a copper alloy and the outer layer comprises stainless steel.

22. The spring of claim 19, wherein the outer layer comprises two different and unmixed materials, a first one of the materials disposed along a first portion of arc of a cross-section of the spring wire, a second one of the materials disposed along a second portion of arc of the spring wire cross-section.

23. The spring of claim 22, wherein the first and second portions of arc each comprise 180°.

24. The spring of claim 15, wherein the spring has a conductivity that is at least 50% the conductivity of pure copper.

25. A multilayered canted coil spring, comprising:
a spring wire including an inner core and an outer layer at least partially surrounding the core;
wherein the outer layer comprises two different and unmixed materials, a first one of the materials disposed along a first portion of arc of a cross-section of the core, a second one of the materials disposed along a second portion of arc of the core cross-section; and
wherein the spring wire defines a plurality of helical coils, each coil surrounding a spring axis that passes through a center of each coil, each coil being tilted to lean at an angle relative to a line that is perpendicular to the spring axis.

26. The spring of claim 25, wherein the first and second portions of arc each comprise 180°.

27. The spring of claim 25, wherein the core comprises copper.

28. The spring of claim 25, wherein the spring has a conductivity that is at least 50% the conductivity of pure copper.
